(19) United States
(12) Patent Application Publication
(10) Pub. No.: US 2005/0028364 A1
(43) Pub. Date: Feb. 10, 2005

(54) Method for producing a piston or piston head for an internal combusition engine

(76) Inventor: Wolfgang Issler, Schwaikheim (DE)

Correspondence Address: WILLIAM COLLARD;COLLARD & ROE, P.C., 1077 NORTHERN BOULEVARD, ROSLYN, NY, 11576, US

(21) Appl. No.: 10/490,273

(22) PCT Filed: Jul. 30, 2002
(86) PCT No.: PCT/DE02/02768

(30) Foreign Application Priority Data
Sep. 19, 2001 (DE) 101 46 079.1

(51) Int. Cl. B23P 15/10; B21K 1/18

(52) U.S. Cl. 29/888.042; 29/888.04; 29/888.044; 29/888.048

(57) ABSTRACT

The invention relates to a method for producing a piston or piston head with a combustion relief (6) for an internal combustion engine. The aim of the invention is to easily and economically produce pistons having a reduced tendency to scale at the edge of the combustion relief. To this end, the piston is formed from a cylindrical unmachined part (1) made of steel, whereby the rod section has at least one front face (2). The method is characterized by the following steps: A) forming an annulary encircling recess (3) in the front face (2); B) introducing additional material (4) into the recess (3); connecting the additional material (4) to the steel of the unmachined part (1) in an at least partially non-positive manner; C) forging the unmachined part (1), which is formed according to steps A) and B), into a piston blank (5), and; D) machining the piston blank (5) into a piston (10) that is ready to be installed in an internal combustion engine.

The invention relates to a method for the production of a piston or piston head for an internal combustion engine, in accordance with the preamble of claim 1.

It is known that after an engine has run, oxidation is found at the bowl edge, to some extent, on steel pistons having combustion bowls or piston heads consisting of steel, as a function of the operating temperature. This oxidation can result in the formation of cracks and therefore in failure of the component. Known solutions to improve this situation are, for example, coating the finished piston with an oxidation-resistant layer in the bowl edge region, by means of plasma-spraying, as described in the SAE paper 660888 “In-Service Performance of Ceramic and Metallic Coatings in Diesel Engines” or the German patent application file number 100 29 810.9. Likewise, application-welding of more oxidation-resistant materials onto the pre-finished piston or methods such as friction welding of a more oxidation-resistant material onto the bowl edge are known.

Furthermore, a production method for a piston of an internal combustion engine is known from DE 199 01 770 A1, in which a piston that has been made ready, i.e. machined to a finished state, has a circumferential, ring-shaped recess that has been made in the head region, into which copper/aluminum wire rods are later placed and melted, so that the ring-shaped recess has an Al/Cu layer structure. Completion of the piston takes place by means of final machining that is performed essentially only in the ring-shaped, circumferential region.

The disadvantage of the methods mentioned is that the starting point is a piston that has already been machined, to which oxidation-resistant materials are then applied in the head region or the depression region of the piston, by means of the methods described, and then the piston has to be machined once again. All of these solutions interrupt the process of machining, and furthermore require heat treatment in order to reduce the inherent stresses that occur between the piston and the oxidation-resistant material.

The invention is therefore based on the task of indicating a production method for a piston having a reduced tendency to oxidize at the bowl edge, which method is simplified and inexpensive in comparison with the state of the art.

This task is accomplished, according to the invention, by means of the characterizing method steps of claim 1. Advantageous further developments are the object of the dependent claims.

Because the production of a forged steel piston, i.e. steel piston head takes place from a cylindrically shaped steel rod segment, which has at least one flat face formed at a right angle to the longitudinal axis of the rod segment, a ring-shaped, circumferential recess can be formed in that region of the face in which the bowl edge of the combustion bowl will later be formed, in simple manner. The pre-heating that is required for the subsequent conventional forging has the effect that the inherent stress between the steel piston material and the oxidation-resistant material is reduced in such a manner that no additional heat treatment is required. Usually, the temperatures for this amount to approximately 850-900° C.

It is true that the recess into which oxidation-resistant material is welded before forging deforms during forging, but after forging it essentially comes to rest at the bowl edge of the combustion bowl, so that completion of the piston or the piston head can be carried out without interrupting the subsequent machining.

In another advantageous embodiment of the production method, a piston or piston head can be produced in that the oxidation-resistant material is welded onto the flat face, in the region of the subsequent bowl edge, in an amount such that after forging and final finish machining, the formation of an oxidation-resistant bowl edge is possible.

The invention will be explained in greater detail in the following, using an exemplary embodiment. The figures show:

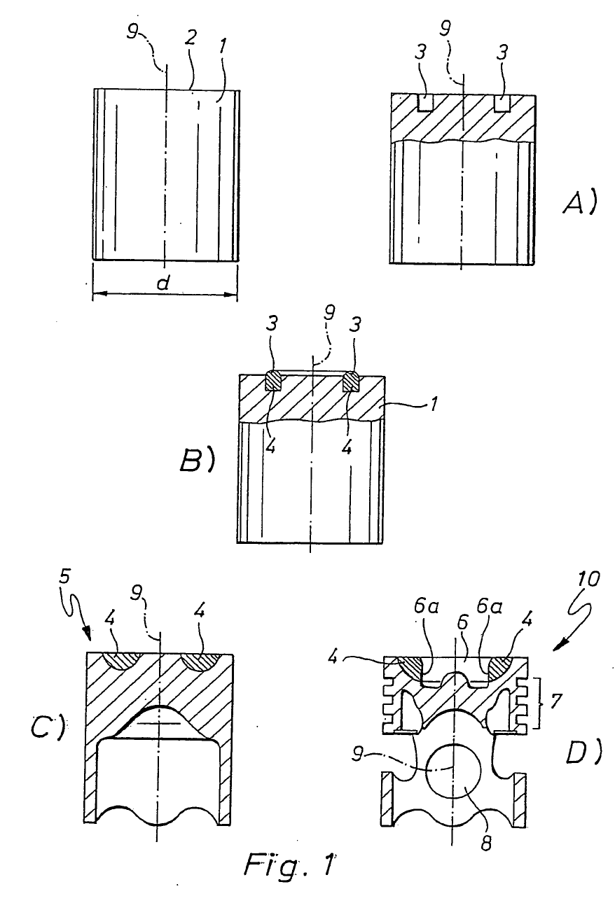

FIG. 1 schematically, the sequence of the production method according to the invention, in steps A to D, in a first embodiment;

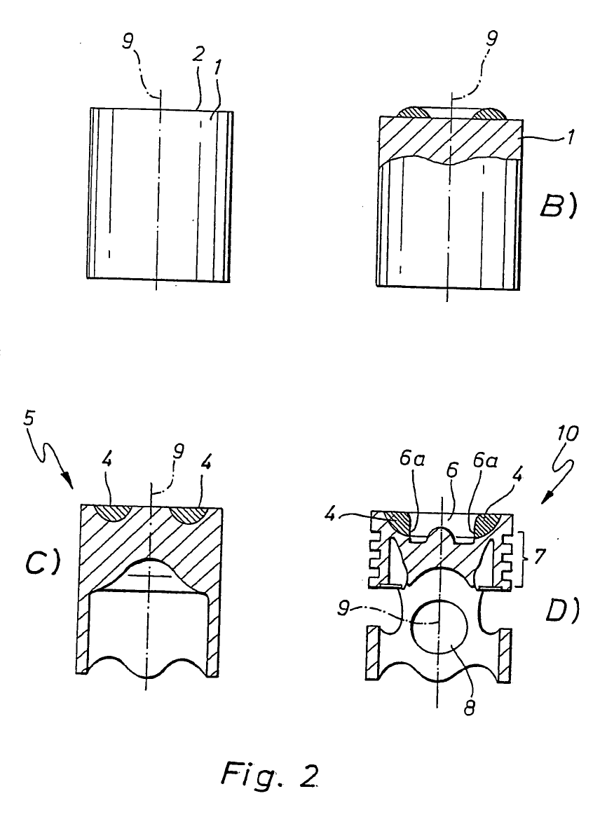

FIG. 2 schematically, the sequence of the production method according to the invention, in steps B to D, in a second embodiment;

FIG. 3 schematically, the sequence of the production method according to the invention, in steps E to G, in another embodiment.

In FIG. 1, a cylindrical rod segment made of steel, referred to as 1, subsequently referred to as unfinished part 1, which preferably consists of a material 42CrMo4 or 38MnSi6, has a face 2 formed at a right angle to the longitudinal axis 9, which is produced, for example, by means of a lathing process. A circumferential, ring-shaped recess 3 is made in a region of the face 2 (production step A), also by means of lathing, and this later forms a bowl edge 6a of a combustion bowl 6 in the piston 10, i.e. the piston head. This region can amount to 30 to 90 percent of the diameter d of the unfinished part 1, i.e. the subsequent piston nominal diameter, depending on the type of piston to be produced, and the piston size, whereby the depth of the recess 3 can amount to 5-15% of the piston nominal diameter, for example, depending on the type of piston to be produced.

In method step B), an oxidation-resistant material 4, referred to as additional material in the following, is welded in by means of a welding process, for example CO₂ welding, laser welding or electron beam welding, friction welding, explosion plating, or other known connection methods, which material demonstrates no tendency or only a slight tendency to form an oxidation layer at a stress temperature in the internal combustion engine of more than 450° C. Preferably, materials on a nickel basis or valve steel X45CrSi9 can be used for this. The recess 3 is completely filled with oxidation-resistant material 4 after the welding has been performed, and can actually extend beyond the face 2.

Deformation of the rod segment 1 to form a piston blank 5 is implemented by means of known forging methods, as shown in method step C) of FIG. 1. The oxidation-resistant material 4 is deformed by means of the forging, in such a manner that the oxidation-resistant material comes to lie on the entire circumference or at least part of the circumference, in the region of the bowl edge 6a that is formed, whereby, however, local flow of the material 4 into the region of the depression bottom, as a result of the forging, cannot be precluded. Subsequently, finishing of the piston blank to produce a piston 10 that can be used in an internal combustion engine, having the desired combustion bowl 6, ring belt 7, boss 8, etc., takes place by means of machining.

In a second exemplary embodiment of the production method, according to FIG. 2, a piston or piston head can be produced in that the method step B) and therefore the making of a recess 3 in the face 2 is eliminated. Instead, a welding layer of oxidation-resistant material 4 is applied onto the face 2, in a thickness and at least in a circular region, as described above in the first embodiment. All the other method steps are kept the same, in accordance with the information provided for the first exemplary embodiment, FIG. 1.

In another embodiment of the production method, according to FIG. 3, a welding layer of oxidation-resistant material 4 is applied over the entire face 2. The layer thickness of the layer can remain constant, in this connection, but preferably it increases radially outward towards the piston edge, starting from the piston axis, i.e. the longitudinal axis of the rod segment 9. Therefore, the additional material 4 forms a part or the entire surface of the piston towards the combustion space side (piston head), as well as part of the fire ridge, i.e. also the ring belt, on the finished, machined piston.

It lies within the scope of the invention that the production method also comprises piston heads for constructed pistons.

A component with locally different strengths can be produced, analogously, using the same method of production.

### Reference Symbols

1 unfinished part, cylindrical rod segment
2 flat face
3 ring-shaped recess
4 additional material, oxidation-resistant
5 piston blank
6 combustion bowl, i.e. head depression
6a bowl edge region
7 ring belt
8 boss
9 longitudinal axis of the rod segment
10 piston
d diameter of the rod segment
A)-D)method steps
1) cylindrical rod segment having a face formed at a right angle to the axis
A) lathing a ring-shaped recess
B) filling the ring-shaped recess with oxidation-resistant material and subsequent melting
C) forging the piston blank
D) machining the finished piston

1. Method for the production of a piston (10) or piston head for an internal combustion engine, having a combustion bowl (6) provided on the piston head, in which the piston (10) is formed from a cylindrical unfinished part (1) made of steel, whereby the cylindrical unfinished part (1) has at least one flat face (2) that is formed at a right angle to the longitudinal axis (9) of the unfinished part (1), characterized by the steps:
A) forming a ring-shaped, circumferential recess (3) in the face (2);
B) applying additional material (4) into the recess (3), by means of an at least partially non-positive connection between the additional material (4) and the steel of the unfinished part (1);
C) forging the unfinished part (1) produced according to steps A) and B) to produce a piston blank (5);
D) machining the piston blank (5) to produce a finished piston (10), ready for installation in the internal combustion engine.

2. Method according to claim 1, wherein the ring-shaped recess (3) is made in a region of the face (2), positioned in such a manner that in the finished piston (10), it lies in the edge region (6a) of the combustion bowl (6).

3. Method according to claim 1, wherein the additional material (4) is applied by means of welding, whereby the ring-shaped recess (3) is completely filled with additional material (4).

4. Method according to claim 3, wherein the welding takes place by means of CO2 welding, laser welding or electron beam welding, friction welding, explosion plating.

5. Method according to claim 1, wherein the cylindrical unfinished part (1) is formed from a 42CrMo4 or 38MnSi6 material of AFP steel, and that the additional material is formed from a material that demonstrates no tendency or only a slight tendency to form an oxidation layer at a stress temperature in the internal combustion engine of more than 450° C.

6. Method according to claim 5, wherein the additional material is an oxidation-resistant material such as valve steel X45CrSi9 or a material on a nickel basis.

7. Method according to claim 1, wherein a piston (10) ready for installation is produced, leaving out the method step A), in such a manner that the application of additional material takes place in a circular region on the face (2), by means of an at least partially non-positive connection, which region lies in the edge region of the combustion bowl of the finished piston.

8. Method according to claim 1, wherein the edge region of the combustion bowl (6a) is not formed of the additional material (4) over the entire circumference of the combustion bowl (6).

9. Method according to claim 1, wherein a piston (10) ready for installation is produced, leaving out the method step A), in such a manner that the application of additional material (4) takes place over the entire face (2), by means of an at least partially non-positive connection.

10. Method according to claim 9, wherein the additional material (4) increases from the piston axis (9) radially outward up to the piston edge.

11. Method according to claim 9, wherein the additional material (4) forms the entire surface of the piston head at least a part, particularly the bowl edge region (6a), of the finished piston (10), and comprises at least part of the fire ridge.
